(19) United States
(12) Patent Application Publication
(10) Pub. No.: US 2009/0134226 A1
(43) Pub. Date: May 28, 2009

(54) Installation for Monitoring the Manual Transfer of Goods Provided with Identification Carriers

(76) Inventor: Anatoli Stobbe, Barsinghausen (DE)

Correspondence Address: COLLARD & ROE, P.C., 1077 NORTHERN BOULEVARD, ROSLYN, NY, 11576, US

(21) Appl. No.: 11/992,041

(22) PCT Filed: Oct. 12, 2006
(86) PCT No.: PCT/DE2006/001807

§ 371 Date: Mar. 14, 2008

(30) Foreign Application Priority Data
Oct. 14, 2005 (DE) 10 2005 049 740.3

(51) Int. Cl. G06K 7/10; G06K 7/00

(52) U.S. Cl. 235/462.44; 235/439

(57) ABSTRACT

The invention relates to an installation for monitoring the manual transfer of goods provided with identification carriers, by means of a reading appliance which is operated by a user and used to read the identification carrier in a non-contact manner, and an identification data memory. The reading appliance comprises a fixing device by which means it is fixed to the body of the user, and a trigger device by which means it can be freehandedly triggered by the user in order to initiate a reading process.

The invention relates to an installation for monitoring the manual transfer of goods provided with identification carriers according to the preamble of claim 1.

In logistics centres of commercial enterprises, goods are removed from shelves of a central warehouse by logistics workers and placed together on pallets which are then transported as transport units to the branches or wholesalers. In this case, individual goods or smaller units in packages are moved manually. For registering the transfer of goods, the individual goods or goods combined in packages are provided with identification carriers which can be read in a non-contact manner and thus allow tracking of the goods flow. In addition to stationary reading appliances or those attached to means of transport, portable reading appliances can also be provided, which are operated manually by the logistics worker and are used individually to register the goods to be transferred.

A disadvantage of these manual reading appliances is that the registration and handling of the goods must not take place concurrently but successively since one hand of the logistics worker is occupied by the logistics worker himself and optionally the other hand must be used for operating the reading device. For the transfer of the goods, the mobile reading appliance must then be placed or inserted into a holder carried by the logistics worker.

It is the object of the invention to provide an installation for monitoring the manual transfer of goods provided with identification carriers which permits simultaneous registering and handling of the goods in one operation.

This object is achieved in an installation according to the preamble of claim 1 by the features of this claim. Further developments and advantageous embodiments are obtained from the dependent claims.

In the installation according to the invention, the reading applies is fixed to the body of the logistics worker, hereinafter called user, by means of a fixing device so that he has both hands free for handling, i.e. for removal, for transfer and for placement. In order that only the transferred goods are specifically registered, the reading appliance is not continuously ready for reading but is specifically activated by means of the trigger device to initiate a reading process. This ensures that only the removed, transferred and set-down goods are detected and no unintentionally other goods located randomly in the vicinity of the location of the user. The goods transfer can be accelerated appreciably since the user need not interrupt the transfer operation by a separate registration of the identification carrier.

The fixing device can consists of a belt or a cuff and surrounds the body or a body part of the user. It is thereby possible to fit a user with a reading appliance as necessary when reading processes are to be carried out without impairing the removal, transfer or placement of the goods.

Alternatively, the fixing device can consist of an item of clothing of the user, to which the reading appliance is fixed or in which said reading appliance is integrated.

This embodiment of the fixing device improves the wearing comfort and therefore the ergonomics. In addition, the risk of hindrances during work and damage to the components of the reading appliance is reduced.

The reading appliance can comprise at least one reading antenna and at least one transmitting/receiving and evaluating device and the reading antenna can be integrated in the transmitting/receiving and evaluating device or it can be spatially offset from the transmitting/receiving and evaluating device and connected thereto by means of connecting cable.

In the first alternative, the design offers a particularly compact solution secure from damage caused by cable breaks. In the second alternative particularly in reading appliances having a fairly large portion of the weight of the components, the reading antenna can be positioned closer to the reading site whilst heavier components can be fixed to other parts of the body and thus their weight need not be additionally lifted when taking up the goods.

The transmitting/receiving and evaluating device and the reading antenna can be dimensioned for an operating frequency in the HF range or in the UHF range. It is additionally possible that the transmitting/receiving and evaluating device can be dimensioned for an operating frequency in the HF range or in the UHF range and can be switched between the operating frequencies.

Then, both a reading antenna for the HF range and also a reading antenna for the UHF range is connected to said transmitting/receiving and evaluating device. Such a reading appliance can therefore be used alternatively for different types of identification carrier technologies or also universally for a plurality of identification carrier technologies.

The reading antenna for the HF range is preferably configured as a magnetic antenna by a coil and the reading antenna for the UHF range is configured as an electrical antenna by a dipole.

A space-saving configuration of the antennas for both frequency ranges can thus be achieved and it is also possible to interleave both types of reading antenna without any risk of these influencing each other.

In addition, the reading antenna for the HF range and/or for the UHF range can be configured by a shielding located at a distance from the coil or a reflector located at a distance from the dipole as a directional antenna.

This configuration of the antenna has the advantage that even when a plurality of goods are stored adjacent to one another, the goods to be removed and transferred can be selected from the others as a result of the directional effect.

The trigger device can comprise an optical or acoustic sensor or a proximity sensor or a touch sensor.

It is thereby possible to trigger the reading process specifically by the user or also automatically when the object to be removed and transferred is approached or touched.

The optical sensor is configured as a receiver for a light source fixed to a part of the user's body, preferably to the head.

To trigger the reading process, the user directs the beams from the light source onto the optical sensor.

The acoustic sensor can be configured as a voice recognition circuit for commands spoken by the user.

This also allows an initiation of the reading process specifically influenced by the user and it is possible to control different phases of the removal, transfer or placement by different commands.

In the case of a proximity sensor, this can be configured as an ultrasound or radar sensor.

In this case, automatic triggering takes place as the object to be registered is approached as soon as a predefined minimum distance is fallen below.

In the case of a touch sensor, this can be configured as a mechanical key or a piezoelement.

Thus, the reading process is only triggered when the object to be registered is touched. In this case, the reading process can take place at a minimum reading distance so that only a low transmitting power need be applied by the reading appliance for the data transmission.

According to a further development, the transmitting/receiving and evaluating device comprises a transmitting power control circuit connected to the trigger device by which means the transmitting power can be increased from an initial value continuously or in steps up to a successful reading process.

Since other reading appliances for identification carriers are frequently also used in logistics centres, there is basically a risk of the different identification carriers and reading appliances influencing each other. This possibility of interference can be considerably reduced by the power matching. In addition, since the energy supply to the reading appliance fixed to the user is provided by batteries or rechargeable batteries, the power matching additionally results in a particularly economical use of the energy resources and therefore in a long lifetime of the rechargeable batteries or batteries or a reduction in the capacity of the rechargeable battery or batteries and therefore their mass and volume.

Furthermore, after a successful first reading process, at least one second reading process can be initiated automatically by means of the trigger device with a time delay.

As a result of this further development, a first reading process can be checked for correctness. Depending on the technology, not only individual objects but also in some cases, a plurality of objects can be detected during the removal of objects. There is then the risk that incorrect objects can also be registered. As a result of at least one second reading process, a check can be made if it assumed that when the further reading process is initiated the object has already been removed from a storage shelf by the user and was therefore spatially selected from adjacently stored objects.

The identification data memory can be connected to the transmitting/receiving and evaluating device directly or via a radio interface such as Bluetooth or W-Lan.

Whereas in the first-mentioned case of the identification data memory, additional space and additional weight is required at the user and describing and reading out must be carried out separately, in the second alternative this is displaced. In this case communication takes place via the radio interface which considerably facilitates description, reading out and a central direct checking of the data.

Furthermore, the identification data memory can comprise a comparator between read actual data and stored desired data and a signal device by which means at least deviations of the read actual data from stored desired data can be signalled to the user.

In this further development, the registered goods can be directly monitored and it can thus be signalled to the user when the wrong ones have been removed from a plurality of adjacent objects.

The installation is explained hereinafter with reference to exemplary embodiments shown in the drawings.

In the drawings:

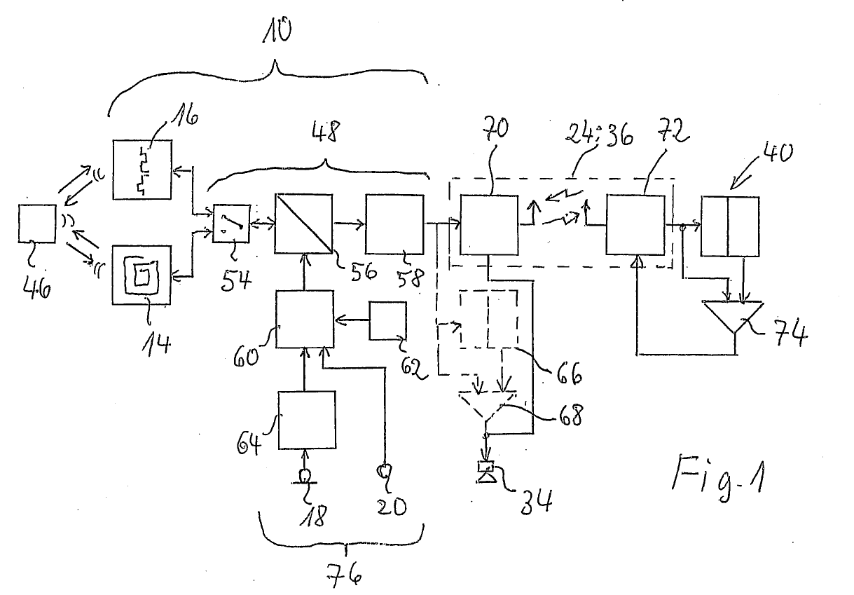

FIG. 1 is a block diagram of an installation for monitoring the manual transfer of goods provided with identification carriers,

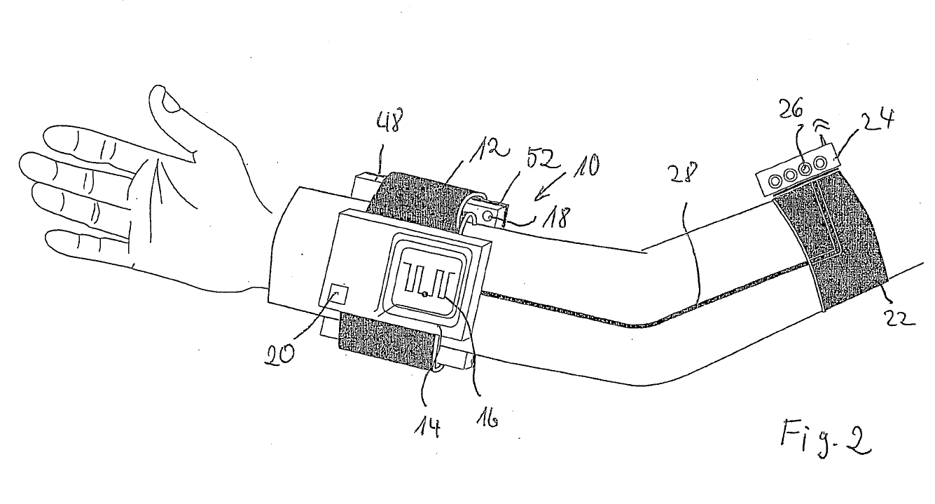

FIG. 2 shows components of the installation fixed to the arm of a user

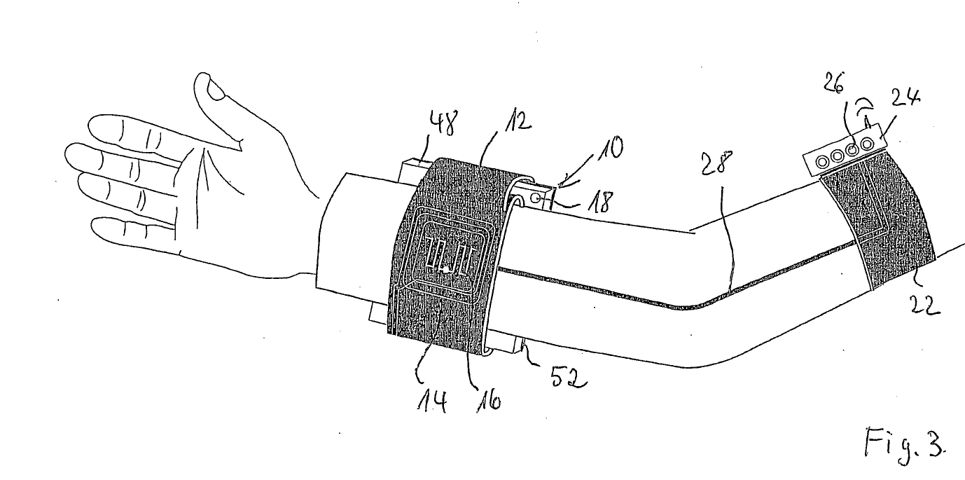

FIG. 3 is a modification of the diagram in FIG. 2 with antennae integrated in a cuff,

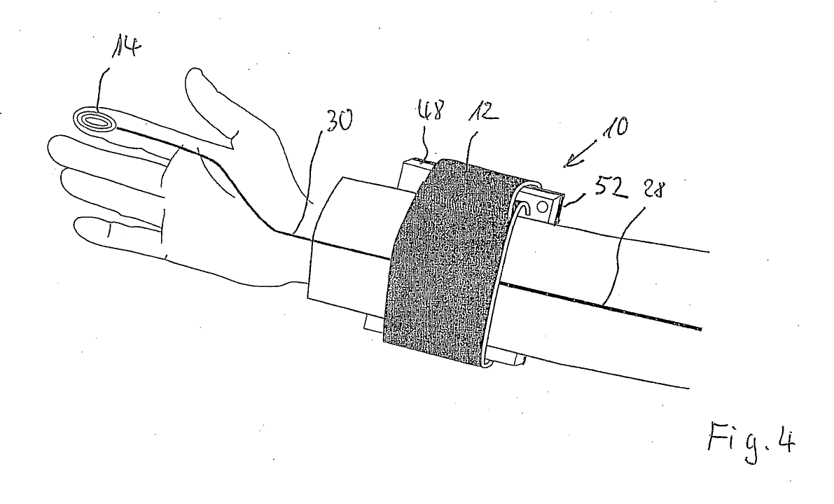

FIG. 4 is a modification of the diagram in FIG. 2 with an antenna integrated in a glove,

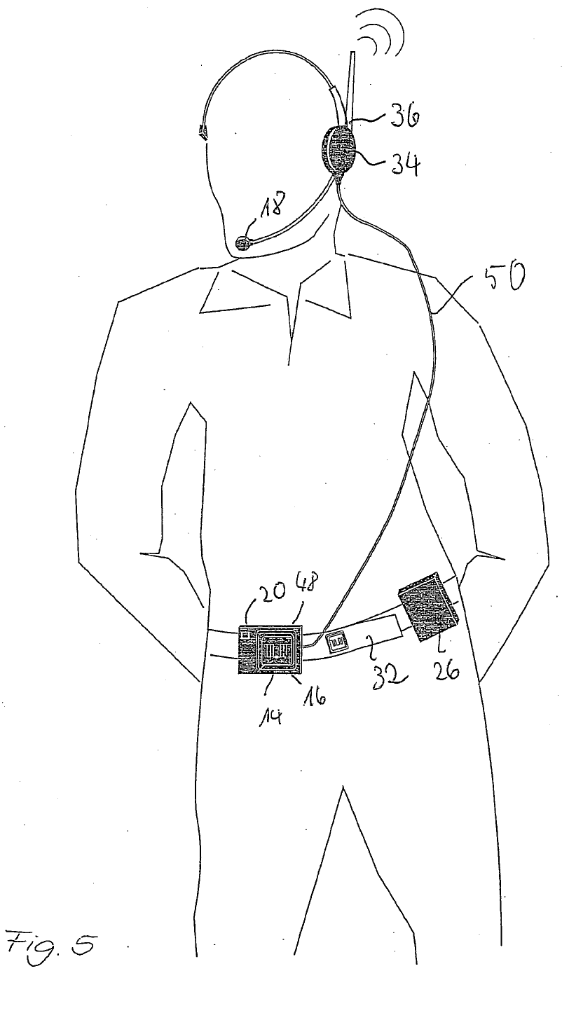

FIG. 5 shows components of the installation fixed to an abdominal belt of a user with a hearing/speech combination affixed to the head,

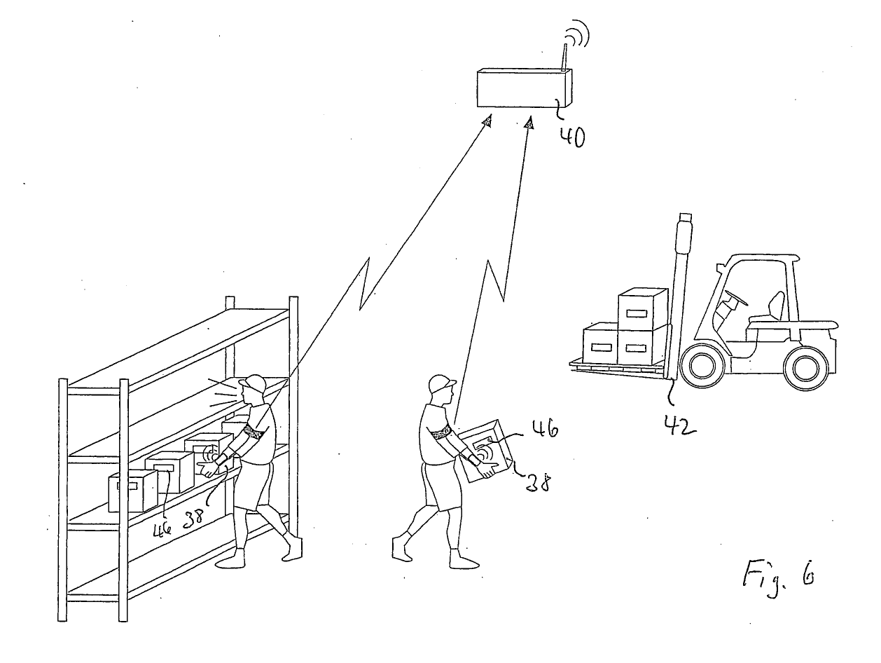

FIG. 6 is an application diagram of the installation according to FIG. 2 with a W-Lan interface and

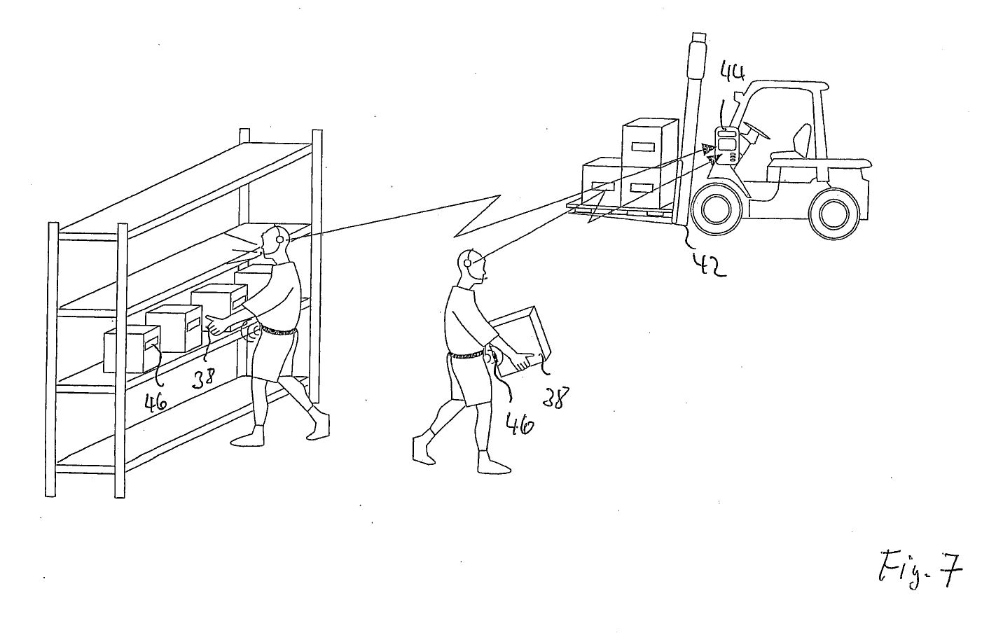

FIG. 7 is an application diagram of the installation according to FIG. 5 with a Bluetooth interface.

FIG. 1 shows a block diagram of an installation for monitoring the manual transfer of goods provided with identification carriers. In order to read out data from information carriers 46, these are supplied with electromagnetic energy from a reading appliance 10 in a non-contact manner and then transmit data to the reading appliance 10 by modulation of the energy field.

The reading appliance 10 comprises an antenna arrangement comprising an HF antenna in the form of a coil 14 and a UHF antenna in the form of a shortened dipole 16. The antennae are connected via a multiplexer 54 to a transmitting/receiving and evaluating device 48 of the reading appliance 10, said transmitting/receiving and evaluating device 48 consisting of a transceiver 56 and an evaluating circuit 58.

The evaluating circuit 58 delivers read data of the information carrier 46 via a radio interface which can be configured as a W-Lan interface 24 or as a Bluetooth interface 36 to an external identification data memory 40 or an external comparator 74 in which the actual data are compared with desired data stored in a memory region of the external identification data memory 40. The radio interface comprises a transceiver 70 connected to the evaluating circuit 58 and a transceiver 72 connected to an external identification data memory 40.

Alternatively, the evaluating circuit 58 can supply read data of the information carrier 46 directly to an internal identification data memory 66 or an internal comparator 68 in which the actual data is compared with the desired data stored in a memory region of the internal identification data memory 66.

The transceiver 56 of the transmitting/receiving and evaluating device 48 is not continuously operating but is temporarily activated by a trigger device 76 to specifically read data from an identification carrier 46. For this purpose, a trigger signal generated by a proximity sensor 20 or a microphone 18 with a voice recognition circuit 64 controls a transmitting power control circuit 60. The transmitting power control circuit 60 in turn increases the transmitting power of the transceiver 56 beginning from a low initial value continuously or in steps until data from the information carrier 46 can be read free from error. The transceiver 56 is then deactivated again. By means of a timer 62, after a time delay has elapsed, the transmitting power control circuit 60 can be automatically activated again at least once more, so that the data of the information carrier 46 can be read once more for monitoring.

If read desired data are compared with stored actual data in the external comparator 74 or in the internal comparator 68 and deviations are determined, this event can also be indicated by a signalling device. For this purpose the external comparator 74 generates an error signal that is passed on to the receiver 34 via the radio interface. Alternatively the internal comparator 68 can also transmit an error signal directly to the receiver 34.

The components of the installation shown in FIG. 2 comprise a reading appliance 10 fixed to the forearm of a user by means of a cuff 12, comprising an antenna arrangement consisting of an HF antenna in the form of a coil 14 and a UHF antenna in the form of a shortened dipole 16 fixed to the inside of the forearm and a transmitting/receiving and evaluating device 48 fixed on the outside of the forearm. The back of the transmitting/receiving and evaluating device 48 has a metal face 52 which serves as shielding for the HF antenna in the form of the coil 14 and as a reflector for the UHF antenna in the form of the shortened dipole 16. The HF antenna and the UHF antenna thus achieve a directional effect in the direction of the inside of the forearm.

Furthermore, a trigger device is provided on the cuff 12 as a component of the transmitting/receiving and evaluating device 48, comprising a voice recognition circuit with a microphone 18 or alternatively a proximity sensor 20. The antenna arrangement with the transmitting/receiving and evaluating device 48 and the trigger device are spatially offset from a battery compartment 26 and a radio interface 24 which are arranged on the upper arm of the user. A connection between the two components is provided by a connecting cable 28.

When the user grasps an object to be transferred, he necessarily moves his forearm close to the identification carrier. A transmitting power control circuit is activated by a voice command or alternatively by the proximity sensor via a control circuit and increases the transmitting power until the data of the identification carrier can be read out free from error. This ensures that only the identification carrier fixed to the grasped object is read and other further adjacent identification carriers on other objects are not detected. In addition, the spurious radiation in the surroundings and therefore an interfering influence on other reading appliances is minimised. Ultimately, the energy source which is carried along is subject to very gentle loading.

Depending on the technology of the identification carrier, the identification carrier is activated and its data read out by alternate activation of the HF range and the UHF range.

Whereas in the embodiment according to FIG. 2, the coil of the HF antenna and the shortened dipole of the UHF antenna are printed on a printed circuit board, in the embodiment according to FIG. 3 the conductors of both antennae 14; 16 are woven into the textile material of the cuff 12.

In addition, in the embodiment according to FIG. 4, the HF antenna 14 is located in a glove in the area of the index finger of the user and is connected via antenna cable 30 to the transmitting/receiving and evaluating device 48.

In the diagram in FIG. 5, the components as shown in FIG. 2 are not arranged on the arm but along an abdominal belt 32 worn by the user. Instead of a microphone arranged on a transmitting/receiving and evaluating device 48 for a voice recognition circuit, the user wears a talk-listen combination comprising a microphone 18 and a receiver 34 on the head which is connected to the transmitting/receiving and evaluating device 48 by means of a connecting cable 50. At the same time, a radio interface 36 is located in the talk-listen combination which can be implemented as a Bluetooth or W-Lan interface and makes a connection to an external identification data memory 40.

FIGS. 6 and 7 shows examples of application of the installation where logistics workers remove goods 38 from a shelf and transfer them to a pallet of a fork lift truck 42.

In FIG. 6 the components of the installation fixed on the body are attached to the arm. In this case, a first reading of the identification data when grasping the objects 38 is made via a voice command or a proximity sensor and a further control reading is made during transfer to the pallet. According to FIG. 6, the read identification data are transmitted via a W-Lan interface to an external identification data memory 40. Alternatively they can be transmitted via a Bluetooth interface to a control terminal of the fork lift truck 42 and from there they can be transmitted again via a W-Lan interface to an external identification memory.

In FIG. 7 the components of the installation are arranged on an abdominal belt of the user and can be triggered via a talk-listen combination or a proximity sensor. Here also a first reading takes place after removing the goods and approaching the abdominal belt and a control reading takes place during transfer to the fork lift truck.

Here the radio interface is implemented as a Bluetooth interface to a control terminal 44 of the fork lift truck 42. Alternatively it can be implemented as a W-Lan interface to an external identification data memory.

In the diagram in FIG. 7 a comparison can also be made between actual and desired data by means of an external comparator and if an object is incorrect, an error message can be signalled to the return path via the headphone 34.

1: Installation for monitoring the manual transfer of goods provided with identification carriers by means of a reading appliance carried by a user to read the identification carrier in a non-contact manner and an identification data memory, wherein the reading appliance comprises a fixing device by which means it is fixed to the body of the user and a trigger device by which means it can be freehandedly triggered by the user to initiate a reading process.

2: The installation according to claim 1, wherein the fixing device consists of a belt or a cuff and surrounds the body or a body part of the user.

3: The installation according to claim 1, wherein the fixing device consists of an item of clothing of the user to which the reading appliance is fixed or in which said reading appliance is integrated.

4: The installation according to claim 1, wherein the reading appliance comprises at least one reading antenna and at least one transmitting/receiving and evaluating device and that the reading antenna is integrated in the transmitting/receiving and evaluating device.

5: The installation according to claim 1, wherein the reading appliance comprises at least one reading antenna and at least one transmitting/receiving and evaluating device and that the reading antenna is spatially offset from the transmitting/receiving and evaluating device and is connected thereto by means of connecting cable.

6: The installation according to claim 4, wherein the transmitting/receiving and evaluating device and the reading antenna is dimensioned for an operating frequency in the HF range or in the UHF range.

7: The installation according to claim 4, wherein the transmitting/receiving and evaluating device is dimensioned for an operating frequency in the HF range or in the UHF range and can be switched between the operating frequencies and a reading antenna for the HF range and also a reading antenna for the UHF range is connected to said transmitting/receiving and evaluating device.

8: The installation according to claim 4, wherein the reading antenna for the HF range is configured as a magnetic antenna by a coil and the reading antenna for the UHF range is configured as an electrical antenna by a dipole.

9: The installation according to claim 8, wherein the reading antenna for the HF range and/or for the UHF range is configured by a shielding located at a distance from the coil or a reflector located at a distance from the dipole as a directional antenna.

10: The installation according to claim 1, wherein the trigger device comprises an optical or acoustic sensor or a proximity sensor or a touch sensor.

11: The installation according to claim 10, wherein the optical sensor is configured as a receiver for a light source fixed to a body part of the user, preferably to the head.

12: The installation according to claim 10, wherein the acoustic sensor is configured as a voice recognition circuit for commands spoken by the user.

13: The installation according to claim 10, wherein the proximity sensor is configured as an ultrasound or radar sensor.

14: The installation according to claim 10, wherein the touch sensor is configured as a mechanical key or a piezoelement.

15: The installation according to claim 1, wherein the transmitting/receiving and evaluating device comprises a transmitting power control circuit connected to the trigger device by which means the transmitting power can be increased from an initial value continuously or in steps up to a successful reading process.

16: The installation according to claim 1, wherein after a successful first reading process, at least one second reading process can be initiated automatically by means of the trigger device with a time delay.

17: The installation according to claim 1, wherein the identification data memory is connected to the transmitting/receiving and evaluating device directly or via a radio interface such as Bluetooth or W-Lan.

18: The installation according to claim 1, wherein the identification data memory comprises a comparator between read actual data and stored desired data and a signal device by which means at least deviations of the read actual data from stored desired data can be signalled to the user.
